(19) United States
(12) Patent Application Publication
(10) Pub. No.: US 2019/0132461 A1
(43) Pub. Date: May 2, 2019

(54) IMAGE FORMING SYSTEM

(71) Applicant: SHARP KABUSHIKI KAISHA, Osaka (JP)

(72) Inventors: KIWAMU MORITA, Sakai City (JP); AYUMU ODA, Sakai City (JP)

(21) Appl. No.: 16/178,421

(22) Filed: Nov. 1, 2018

(30) Foreign Application Priority Data
Nov. 1, 2017 (JP) 2017-212004

(51) Int. Cl. H04N 1/00

(52) U.S. Cl. CPC H04N 1/00533; H04N 1/00129; H04N 1/00535; H04N 1/00546; H04N 1/00278

(57) ABSTRACT

An image forming system includes an image forming apparatus and a separate unit separated from the image forming apparatus. The image forming apparatus includes an opening/closing section that is provided on the front side of the image forming apparatus and opens frontward. The separate unit is configured to be movable along a predetermined movement path between a predetermined first position at which the opening/closing section is openable/closable and a predetermined second position that is positioned in front of the image forming apparatus. At the second position, the separate unit blocks at least part of the opening/closing section in such a manner that the opening/closing section is not opened.

### BACKGROUND

### 1. Field

The present disclosure relates to an image forming system.

### 2. Description of the Related Art

A known image forming system includes an image forming apparatus, such as a copier, a multifunction machine, and a printer, and a separate unit that is separated from the image forming apparatus. An example of the separate unit is an operation unit that is operable by users. More specifically, the operation unit is, for example, an information processing terminal that is installed in facilities, such as post offices or convenience stores, and serves for providing municipal services, such as printing various certificates including a certificate of residence or a certificate of a seal-impression. In recent years, such an image forming system has been desired to reduce the footprint and save the space available for the system so that the image forming system can be installed in small-scale facilities where the installation space is limited.

A type of image forming apparatus used for the image forming system has an opening/closing section (such as, a sheet container that can be drawn frontward and/or an opening/closing cover that can be turned frontward). The opening/closing section is disposed on the front side of the image forming apparatus and opens frontward. The image forming apparatus is desired to restrain the opening/closing section from opening unintendedly frontward of the image forming apparatus.

In this regard, Japanese Unexamined Patent Application Publication No. 2003-29600 discloses an image forming system in which an opening; closing door is rotatably disposed on a side of an image forming apparatus and an option module is also rotatably disposed on the side of the image forming apparatus so as to hide the opening/closing door.

According to Japanese Unexamined Patent Application Publication No. 2003-29600, the opening/closing door and the option module are opened/closed on a side of the image forming apparatus. However, the opening/closing section is not formed so as to suppress unintended opening toward a region in front of the image forming apparatus.

It is desirable that an image forming system have an image forming apparatus and a separate unit separated from the image forming apparatus and be able to save a space available for the image forming system and to suppress an opening/closing section from opening unintendedly frontward of the image forming apparatus.

### SUMMARY

According to an aspect of the disclosure, there is provided an image forming system that includes an image forming apparatus and a separate unit that is separated from the image forming apparatus. In the image forming system, the image forming apparatus includes an opening/closing section that is disposed on a front side of the image forming apparatus and that opens frontward. In addition, the separate unit is configured to be movable along a predetermined movement path between a predetermined first position at which the opening/closing section is openable/closable and a predetermined second position that is positioned in front of the image forming apparatus and at which the separate unit blocks at least part of the opening/closing section in such a manner that the opening/closing section is not opened.

### BRIEF DESCRIPTION OF THE DRAWINGS

FIG. 1 is a schematic perspective view illustrating a state in which a separate unit is located at a second position in an image forming system according to a first embodiment;

FIG. 2 is a schematic perspective view illustrating a state in which the separate unit is located between a first position and the second position in the image forming system according to the first embodiment;

FIG. 3 is a schematic front view illustrating the state in which the separate unit is located between the first position and the second position in the image forming system according to the first embodiment;

FIG. 4 is a schematic plan view illustrating an initial screen image displayed on a first display that is disposed in the separate unit;

FIG. 5 is a schematic perspective view illustrating a state in which a separate unit is located at a second position in an image forming system according to a second embodiment;

FIG. 6 is a schematic plan view illustrating a state in which the separate unit is located at a first position in the image forming system according to the second embodiment;

FIG. 7 is a schematic perspective view illustrating a state in which a separate unit is located at a first position in an image forming system according to a third embodiment;

FIG. 8 is a schematic plan view illustrating a state in which the separate unit is located at the first position in the image forming system according to the third embodiment.

### DESCRIPTION OF THE EMBODIMENTS

Exemplary embodiments will be described with reference to the drawings.

### Overall Structure of Image Forming System

### First Embodiment

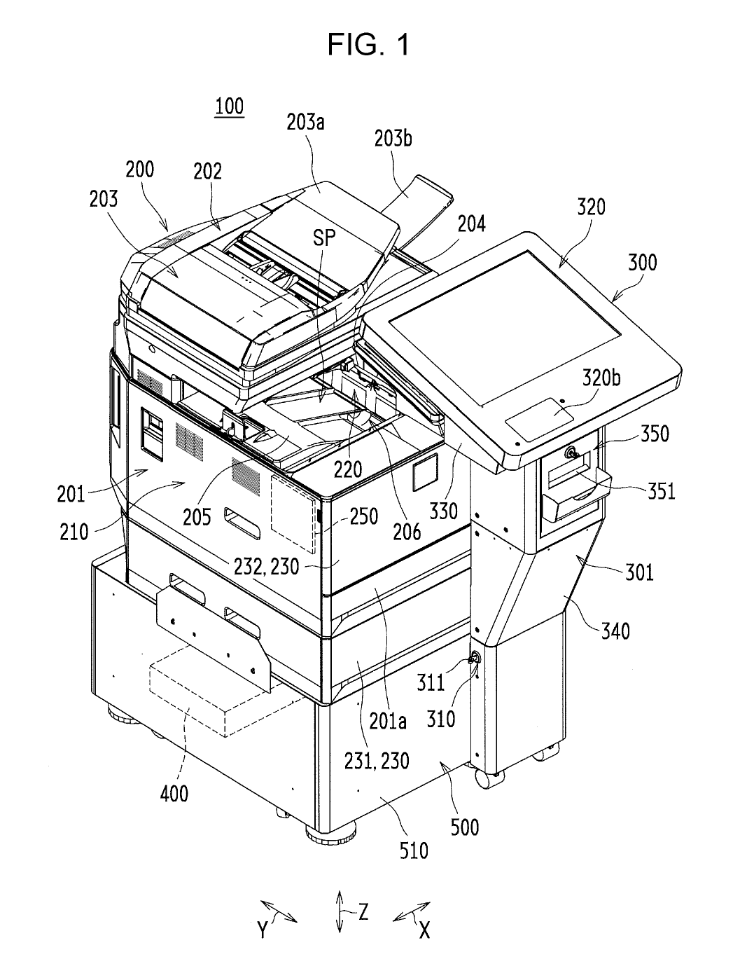

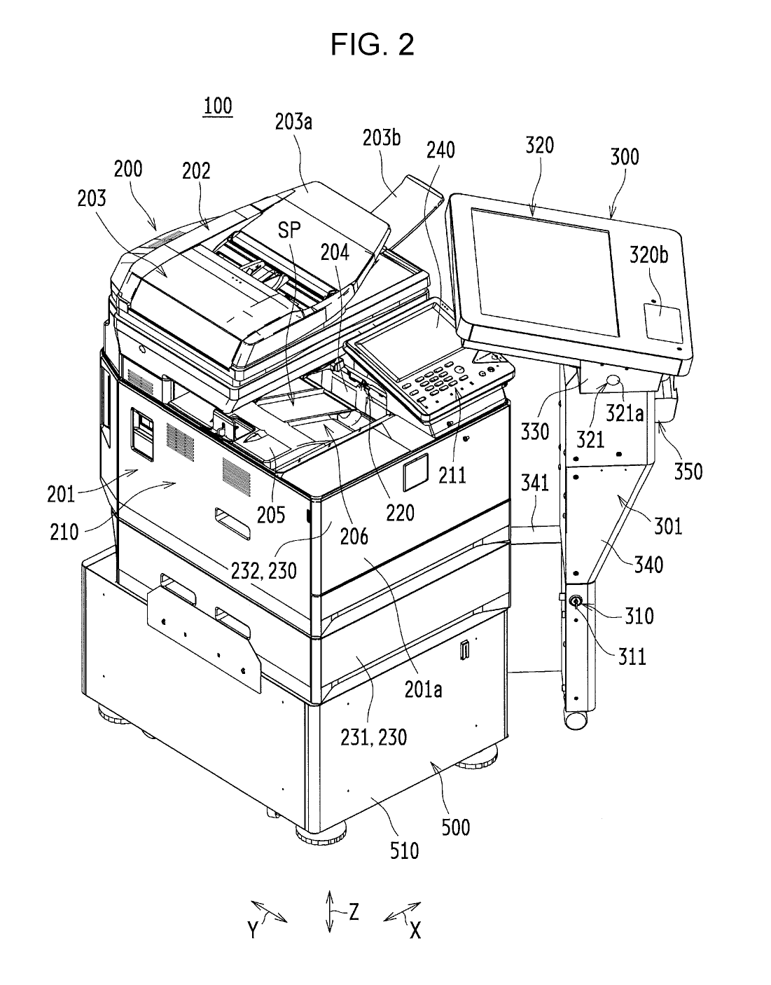

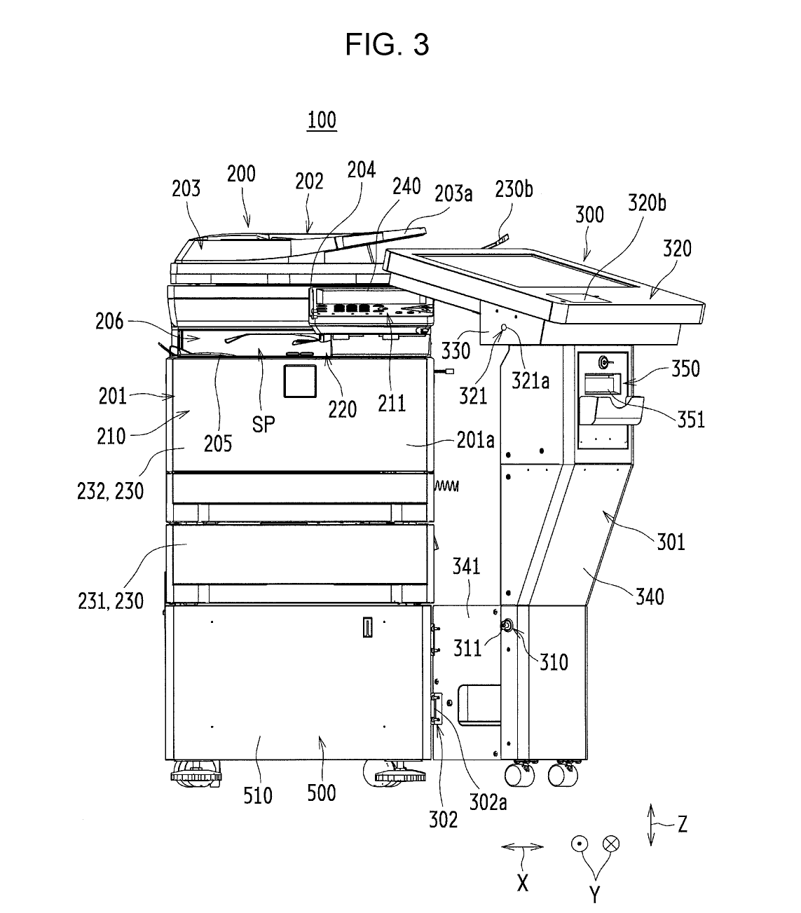

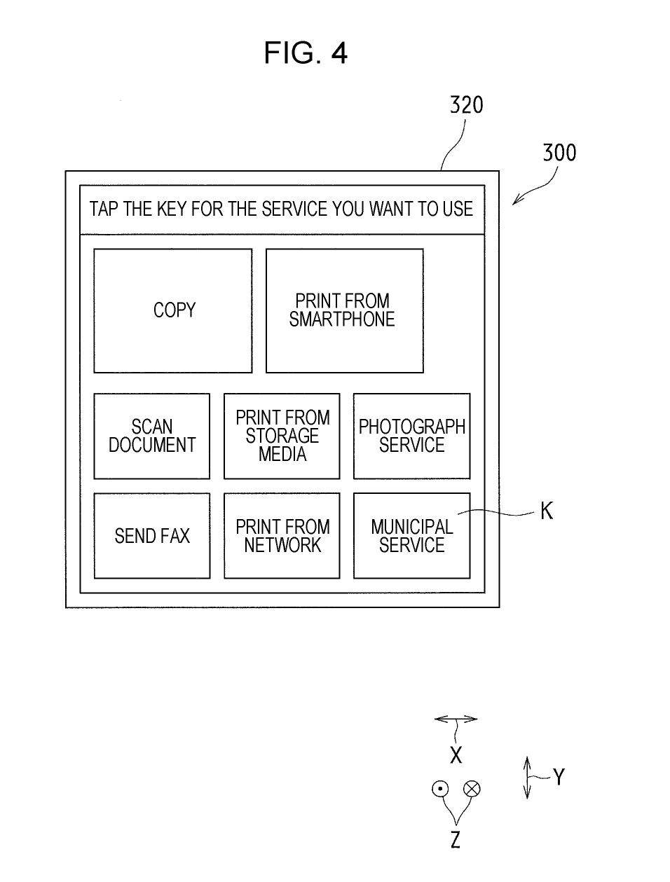

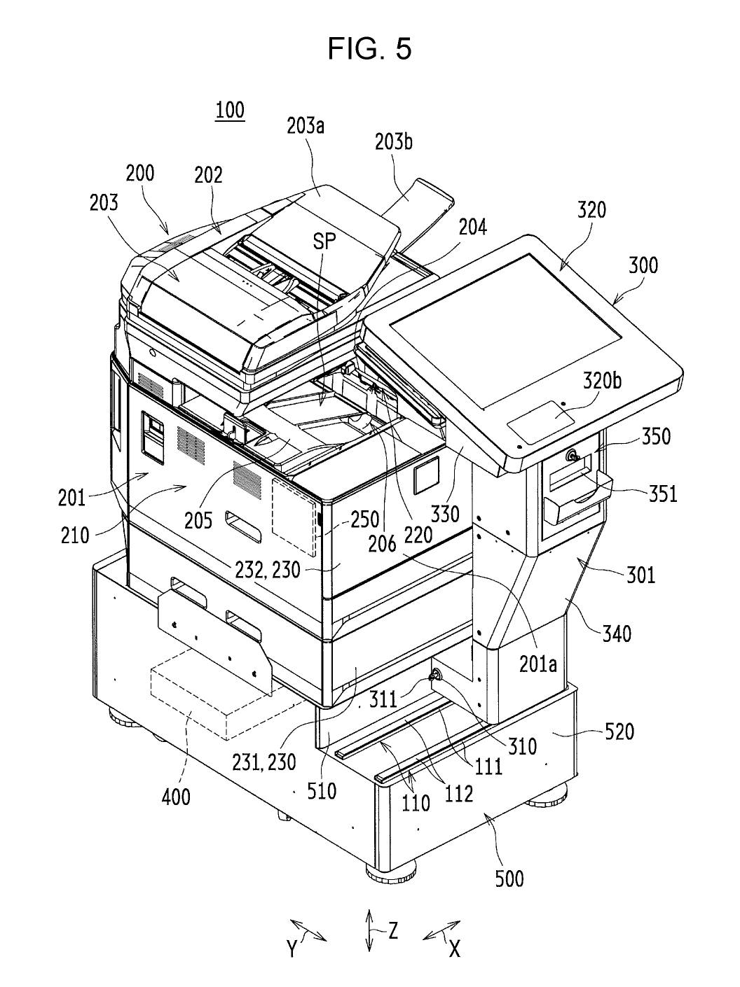

FIG. 1 is a schematic perspective view illustrating a state in which a separate unit 300 is located at a second position in an image forming system 100 according to a first embodiment. FIG. 2 is a schematic perspective view and FIG. 3 is a schematic front view, both of which illustrate a state in which the separate unit 300 is located between a first position and the second position in the image forming system 100 according to the first embodiment. In addition, FIG. 4 is a schematic plan view illustrating as initial screen image displayed on a first display 320 that is disposed in the separate unit 300. Note that in FIGS. 1 to 4 as well as FIGS. 5 to 8, which will be described later, the right-left direction, the front-rear direction, and the up-down direction of an image forming apparatus 200 are denoted by references X, Y, Z, respectively.

The image forming system 100 according to the present embodiment includes the image forming apparatus 200 and the separate unit 300 that is functionally different from the image forming apparatus 200. An example of the separate unit 300 is an operation unit that is operable by users. More specifically, the operation unit is, for example, an information processing terminal that is installed in facilities, such as post offices or convenience stores, and serves for providing municipal services, such as printing various certificates including a certificate of residence or a certificate of a seal-impression. In the case of providing such municipal services from the image forming system 100, the image forming system 100 displays a key K for municipal services on an initial screen image of a first display 320 as illustrated in FIG. 4 and accepts user's selection of the key K. In accordance with user's personal identification data (specifically, data recorded in an IC card such as an “Individual Number Card”) that is read by a data reading device 320b (specifically, an IC card reader), the image forming apparatus 200 prints various certificates such as a certificate of residence or a certificate of a seal-impression. In this case, the user pays the charge by using a payment apparatus (so-called a “coin vendor”) installed next to the image forming apparatus 200 (not illustrated), and the user receives a receipt printed by a printer 350.

The image forming apparatus 200, which is equipped with image bearing members (specifically, photosensitive drums), forms an image on a sheet such as a recording sheet of paper (not illustrated) in accordance with image data transmitted from an external device. In the present example, the maximum size of image that the image forming apparatus 200 can form is A4 size. The image forming apparatus 200 can be a monochrome image forming apparatus or a color image forming apparatus (for example, a tandem type color image forming apparatus).

The image forming apparatus 200 includes an image forming apparatus body 201 and an image reading apparatus 202. An image forming section 210 and a sheet transport system 220 are disposed in the image forming apparatus body 201.

An opening/closing section 230 is provided on a front side (on a user operation side) of the image forming apparatus 20). The opening/closing section 230 opens frontward. Here, the user operation side is the front side of the image forming apparatus 200, and the side opposite to the user operation side is the rear side of the image forming apparatus 200. The opening/closing section 230 includes a sheet container 231 that can be drawn frontward and/or an opening/closing cover 232 that can be turned frontward (in the present example, the opening/closing section 230 includes both of the sheet container 231 and the opening/closing cover 232). In the present example, the sheet container 231 includes a single sheet tray. However, the sheet container 231 may include several sheet trays arranged in tiers in the up-down direction Z In addition, the opening/closing section 230 is opened/closed by specified users. The specified users are, for example, staff members in the facilities or service people.

The separate unit 300 is configured to be movable along a predetermined movement path between a predetermined first position at which the opening/closing section 230 is openable/closable and a predetermined second position that is positioned in front of the image forming apparatus 200. At the second position, the separate unit 300 blocks at least part of the opening/closing section 230 in such a manner that the opening/closing section 230 is not opened.

According to the image forming system 100 of the present embodiment, the separate unit 300 is configured to be movable between the first position at which the opening/closing section 230 is openable/closable and the second position positioned in front of the image forming apparatus 200. With this configuration, space can be utilized effectively. In other words, this enables the installation space for the image forming system 100 to be reduced. The separate unit 300 is also configured to block at least part of the opening/closing section 230 in such a manner that the opening/closing section 230 is not opened when the separate unit 300 is located at the second position that is in front of the image forming apparatus 200. With this configuration, the separate unit 300 obstructs opening/closing of the opening/closing section 230. This can suppress the opening/closing section 230 from opening unintendedly frontward of the image forming apparatus 200.

More specifically, unspecified general users use the image forming system 100. If unspecified general users can open or close the opening/closing section 230 freely, there may arise a problem of missing components from the image forming apparatus 200 or missing sheets from the sheet container or a problem of malfunction due to improper operation of components in the image forming apparatus 200. Conventionally, to avoid such a problem, access to an opening/closing section has been limited to specified users (for example, staff members in the facilities or service people), and the specified users have locked the opening/closing section (or each individual opening/closing section if multiple opening/closing sections are available). Thus, it is desirable that the opening/closing section 230 be restrained from opening/closing freely by unspecified general users. According to the image forming system 100 of the present embodiment, the separate unit 300 blocks at least part of the opening/closing section 230 in such a manner that the opening/closing section 230 is not opened when the separate unit 300 is located at the second position. Accordingly, the opening/closing section 230 can effectively suppress the likelihood of unspecified general users opening/closing the opening/closing section 230 freely. For example, the opening/closing section 230 is inhibited from opening/closing on normal occasions (when opening/closing of the opening/closing section 230 is not requested), and the opening/closing section 230 is allowed to open/close only when it is requested (in the case of maintenance operations, such as supplying sheets, dealing with sheet jamming, changing toner or changing a developing agent).

A known image forming system includes a large image forming apparatus (specifically, image forming apparatus capable of forming maximum A3 size images) and a separate unit, and the large image forming apparatus and the separate unit are installed side by side in a relatively large installation area. Moreover, installation of such a known image forming apparatus has normally included heavy load transportation and a number of workers. According to the image forming system 100 of the present embodiment, the separate unit 300 is configured to be movable between the first position and the second position. As a result, even in the case in which the size and weight of the image forming apparatus 200 and the separate unit 300 are reduced, the separate unit 300 can function appropriately. Moreover, an existing image forming apparatus 200 can be utilized for the image forming system 100.

In the image forming system 100 according to the present embodiment, the separate unit 300 has a lock 310 that locks the separate unit 300 at the second position. The separate unit 300 can be locked at the second position with a key 311 that corresponds to the lock 310, which securely inhibits opening of the opening/closing section 230. Even in the case of providing a plurality of the opening/closing sections 230 as in the present embodiment (two opening/closing sections 230 such as the sheet container 231 and the opening/closing cover 232 are present in the present example), the opening/closing sections 230 can be locked with a single lock 310 without the necessity of providing respective locks for the opening/closing sections 230. Here, the lock 310 can be a lock including a mechanical lock and an electronic lock. The key 311 corresponding to the lock 310 encompasses, for example, a mechanical key, a card key such as an IC card, biometric authentication using fingerprints, confidential information such as passwords, or any combination thereof. The key 311 can be kept and/or registered by specified users.

In the image forming system 100 according to the present embodiment, the first position is a position other than the position in front of the image forming apparatus 200. Space in front of the image forming apparatus 200 can be thereby made available. The first position, which is different from the position in front of the image forming apparatus 200, is a position at which the separate unit 300 does not overlap the opening/closing section 230 when viewed from a region in front of the image forming apparatus 200. On the other hand, the second position, which is the position in front of the image forming apparatus 200, is a position at which the separate unit 300 overlaps the entire portion or a portion of the opening/closing section 230 when viewed from a region in front of the image forming apparatus 200.

The image forming system 100 according to the present embodiment includes the first display 320 that is disposed in the separate unit 300 and a second display 240 (see FIGS. 2 and 3) that is disposed in the image forming apparatus 200. The first display 320 are normally viewed by unspecified general users. The second display 240 is normally viewed by specified users. If the first display 320 covers at least part of the second display 240 when the separate unit 300 is located at the first position, the specified users may not view the second display 240 clearly. On the other hand, if the first display 320 uncovers the entire portion of the second display 240 when the separate unit 300 is located at the second position, the unspecified general users are confused as to which to view between the first display 320 and the second display 240. Accordingly, it is desirable that specified users be able to view the second display 240 easily when the separate unit 300 is located at the first position. It is also desirable that unspecified general users be directed to viewing the first display 320 between the first display 320 and the second display 240 when the separate unit 300 is located at the second position.

In the present embodiment, the first display 320 uncovers the entire portion of the second display 240 when the separate unit 300 is located at the first position, whereas the first display 320 covers (hides) at least part of the second display 240 (i.e., covers the entire portion or a portion of the second display 240) when the separate unit 300 is located at the second position. Thus, when the separate unit 300 is located at the first position, the first display 320 can uncover the entire portion of the second display 240, and thereby specified users can view the second display 240 easily. In addition, when the separate unit 300 is located at the second position, the first display 320 can cover at least part of the second display 240. Unspecified general users are thereby directed to viewing the first display 320 between the first display 320 and the second display 240.

In the present example, the screen size (i.e., the overall size) of the first display 320 is larger than that of the second display 240. The first display 320 overlaps the second display 240 so as to hide the entire portion of the second display 240 when the separate unit 300 is located at the second position (see FIG. 1).

In the present embodiment, the image reading apparatus 202 includes a document feeder 203. The document feeder 203 includes a document feeder tray 203a onto which documents to be read are placed and a document output tray 203b onto which documents discharged are placed.

The document feeder 203 is disposed in upper part of the image forming apparatus 200. When the separate unit 300 is located at the second position, the first display 320 is positioned in front of the document feeder 203. When the separate unit 300 is located at least at the second position, the first display 320 is positioned at a level lower than or equal to the level of the document feeder tray 203a of the document feeder 203 (in the present example, the first display 320 is positioned lower than the level of the document feeder tray 203a). Thus, documents can be placed on the document feeder tray 203a easily without the first display 320 obstructing document placement.

In the present embodiment, the separate unit 300 includes a lower portion 340 that extends downward from the first display 320. This enables the first display 320 to be securely mounted on the separate unit 300 and also to orient the display screen of the first display 320 upward easily. This can improve the visibility of the first display 320. The first display 320 is mounted on a mounting portion 330 of a separate unit body 301.

More specifically, the lower portion 340 is formed so as to follow a front surface 201a of the image forming apparatus 200 (i.e., the image forming apparatus body 201 in the present example). The separate unit 300 can be thereby positioned at the second position smoothly without the front surface 201a of the image forming apparatus 200 obstructing the lower portion 340.

In the present embodiment, when the separate unit 300 is located at the first position, the lower portion 340 causes the opening/closing section 230 to be openable/closable. In addition, when the separate unit 300 is located at the second position, the lower portion 340 blocks at least part of the opening/closing section 230 (i.e., blocks the entire portion or a portion thereof) in such a manner that the opening/closing section 230 is not opened. Thus, when the separate unit 300 is located at the first position, the lower portion 340 ensures opening/closing of the opening/closing section 230. In addition, when the separate unit 300 is located at the second position, the lower portion 340 can securely block at least part of the opening/closing section 230 in such a manner that the opening/closing section 230 is not opened.

In the present embodiment, the first display 320 has a tilt mechanism 321 (see FIGS. 2 and 3) that enables the first display 320 to rotate around a rotation axis extending substantially in a horizontal direction. The first display 320 can be thereby adjusted easily to a position at which the first display 320 is viewed easily. More specifically, the tilt mechanism 321 is disposed in the mounting portion 330. The tilt mechanism 321 has a rotation axis 321a extending in the right-left direction X when the separate unit 300 is located at the second position. The first display 320 is rotatably disposed around the rotation axis 321a.

In the present embodiment, the image forming system 100 includes a control unit 400 (i.e., a control circuit board constituting a personal computer in the present example) that operates and controls the image forming apparatus 200 in accordance with instruction signals from the separate unit 300 (see FIG. 1). The image forming apparatus 200 includes a controller 250 (see FIG. 1) that controls image forming operation of the image forming apparatus body 201. When the separate unit 300 is located at the first position, specified users view the second display 240 only. In this case, activating the first display 320 leads to unnecessary power consumption. When the separate unit 300 is located at the second position, unspecified general users view the first display 240 only. In this case, activating the second display 320 leads to unnecessary power consumption. Moreover, activating the second display 320 confuses unspecified general users as to which display to view between the first display 320 and the second display 240. Accordingly, it is desirable that unnecessary power consumption be avoided and that unspecified general users be directed to viewing the first display 320 between the first display 320 and the second display 240 when the separate unit 300 is located at the second position.

In the present embodiment, the image forming system 100 is configured to switch between a first display state in which the first display 320 is activated and the second display 240 is not activated and a second display state in which the second display 240 is activated and the first display 320 is not activated. The image forming system 100 switches to the first display state when the control unit 400 is supplied with electric power (more specifically, the controller 250 switches to the first display state when a signal indicating the supply of electric power to the controller 250 is present). The image forming system 100 switches to the second display state when the control unit 400 is not supplied with electric power (more specifically, the controller 250 switches to the second display state when a signal indicating the supply of electric power to the controller 250 is not present). Thus, in the first display state, the control unit 400 can cause the image forming apparatus 200 to perform an image forming operation (e.g., to copy) in response to an instruction signal from the separate unit 300 rather than from an operation panel 211 (see FIGS. 2 and 3) of the image forming apparatus body 201. For example, a position sensor (not illustrated) senses whether the separate unit 300 is located at the first position or at the second position, and when the separate unit 300 is sensed to be at the first position, electric power supplied to the control unit 400 is cut off. The electric power supplied to the control unit 400 can be also cut off by a specified user. As a result of electric power being cut off, the second display 240 is only activated without activating the first display 320 when the separate unit 300 is located at the first position. On the other hand, the first display 320 is only activated without activating the second display 240 when the separate unit 300 is located at the second position and the control unit 400 is supplied with electric power as a result of the position sensor sensing separate unit 300 at the second position or of a specified user causing the control unit 400 to be supplied with electric power. Thus, unnecessary power consumption can be avoided. Moreover, when the separate unit 300 is located at the second position, unspecified general users can be directed to viewing the first display 320 between the first display 320 and the second display 240.

More specifically, the image forming system 100 causes the image forming apparatus 200 to perform an image forming operation (e.g., to copy) in the first display state in response to an instruction signal generated when an unspecified user performs menu selection from the first display 320. The image forming system 100 causes the image forming apparatus 200 to perform an image forming operation (e.g., to copy) and other operations in the second display state in response to an instruction signal generated when a specified user performs menu selection from the second display 240. With this configuration, the first display 320 can cover at least part of the second display 240 when the separate unit 300 is located at the second position. Moreover, the image forming apparatus 200 can perform an image forming operation in response to an instruction signal from the first display 320 of the separate unit 300 rather than from the second display 240 of the image forming apparatus body 201.

In the present embodiment, the opening/closing section 230 includes the sheet container 231 that can be drawn frontward and/or the opening/closing cover 232 that can be turned frontward (in the present example, the opening/closing section 230 includes both of the sheet container 231 and the opening/closing cover 232). Thus, when the separate unit 300 is located at the second position, the separate unit 300 can block at least part of the sheet container 231 and of the opening/closing cover 232 in such a manner that the sheet container 231 and the opening/closing cover 232 are not opened. This can suppress unintended opening/closing of the sheet container 231 and the opening/closing cover 232.

In the present embodiment, the image forming apparatus 200 includes the image forming section 210, a discharge section 204, and a discharge tray 205. The image forming section 210 forms an image onto a sheet on the basis of image data that has been read by the image reading apparatus 202 or sent from an external device (for example, from a municipal office). The discharge section 204 discharges the sheet onto which an image has been formed by the image forming section 210. The discharge tray 205 receives the sheet discharged from the discharge section 204. A sheet takeout opening 206 is provided in a front region in the image forming apparatus 200 for taking out the sheet placed on the discharge tray 205. In the present example, the discharge tray 205 is formed as an internal discharge tray on which sheets are placed inside the image forming apparatus body 201. More specifically, an interior discharge space SP is formed between the image reading apparatus 202 and the image forming section 210. The sheet takeout opening 206 is provided in a front region in the interior discharge space SP.

If the separate unit 300 hides the entire portion of the sheet takeout opening 206 when the separate unit 300 is located at the second position, it would be difficult to take out a sheet placed on the discharge tray 205. Accordingly, it is desirable that a sheet be taken out from the discharge tray 205 easily in the case of providing the sheet takeout opening 206 in the front region in the image forming apparatus 200.

In the present embodiment, when the separate unit 300 is located at the second position, the separate unit 300 exposes at least part of the sheet takeout opening 206 (i.e., exposes the entire portion or a portion thereof). Thus, in the case of providing the sheet takeout opening 206 in the front region of the image forming apparatus 200, a sheet placed on the discharge tray 205 can be taken out easily when the separate unit 300 is located at the second position. In addition, the separate unit 300 exposes the entire portion of the sheet takeout opening 206 when the separate unit 300 is located at the first position.

In the present embodiment, the image forming system 100 is equipped with a pedestal 500 on which the image forming apparatus 200 is mounted. A pedestal opening/closing portion 510 is disposed on the front side (on the user operation side) of the pedestal 500. The pedestal opening/closing portion 510 opens frontward. In the present example, the control unit 400 is disposed inside the pedestal 500.

If the pedestal opening/closing portion 510 on the front side of the pedestal 500 is opened/closed unrestrictedly, there may arise a problem of missing consumables, such as sheets and toners, stored in the pedestal 500. In the case of disposing the control unit 400 inside the pedestal 500, the control unit 400 may be gone. Thus, it is desirable to re the pedestal opening/closing portion 510 from opening/closing freely.

In the present embodiment, the pedestal opening/closing portion 510 can be opened/closed when the separate unit 300 is located at the first position. In addition, when the separate unit 300 is located at the second position, the separate unit 300 blocks at least part of the pedestal opening/closing portion 510 (i.e., the entire portion or a portion thereof) in such a manner that the pedestal opening/closing portion 510 is not opened. Thus, the pedestal opening/closing portion 510 can be suppressed effectively from opening/closing freely. For example, the pedestal opening/closing portion 510 is suppressed from opening/closing on normal occasions (when opening/closing of the pedestal opening/closing portion 510 is not requested), whereas the pedestal opening/closing portion 510 is allowed to open/close only when it is requested (when including taking out of consumables, such as sheets or toners). In the present example, the pedestal opening/closing portion 510 is opened/closed by specified users. In the case in which the separate unit 300 has the lock 310 as in the present embodiment, it may be unnecessary to provide a lock for the pedestal opening/closing portion 510. The pedestal opening/closing portion 510 can be locked by the lock 310.

In the present embodiment, the separate unit 300 is movably disposed on the pedestal 500. Thus, the separate unit 300 can be supported stably by the pedestal 500.

In the present embodiment, the separate unit 300 includes the printer 350 that is disposed such that a discharge opening 351 of the printer 350 for discharging a printout faces frontward when the separate unit 300 is located at the second position. Thus, a printout can be taken out easily from the front side of the separate unit 300.

In the present embodiment, the first position is a position on the right or on the left of image forming apparatus 200 (in the present example, on the right thereof). Here, the right and the left of the image forming apparatus 200 are defined when the image forming apparatus 200 is viewed in front of the image forming apparatus 200. When the separate unit 300 is located at the first position, space can be made available between a region on the right of the image forming as 200 and a region in front of the image forming apparatus 200 or a space between a region on the left thereof and a region in front thereof.

Note that the first position may be a position between the region on the right of the image forming apparatus 200 and the region in front of the image forming apparatus 200 or a position between the region on the left thereof and the region in front thereof.

In the present embodiment, the separate unit 300 is formed so as to be rotatable between the first position and the second position around a rotation axis extending in the up-down direction Z. Thus, the separate unit 300 can be rotated reciprocally between the first position and the second position with a simple configuration and with easy operation. More specifically, the separate unit 300 includes an extension portion 341 (see FIGS. 2 and 3) that extends rearward from lower part of the lower portion 340. Accordingly, the lower portion 340 is formed into an L shape in plan view (when viewed from above). The extension portion 341 is attached to the right side of the pedestal 500 via a hinge 302 (see FIG. 3) that has a rotation axis 302a extending in the up-down direction Z.

Note that the first position may be a position at a distance in front of the image forming apparatus 200. In this case, for example, the separate unit 300 may be formed so as to be rotatable between the first position and the second position around a rotation axis extending in the right-left direction X. The first position can be thereby positioned at a distance in front of the image forming apparatus 200.

### Second Embodiment

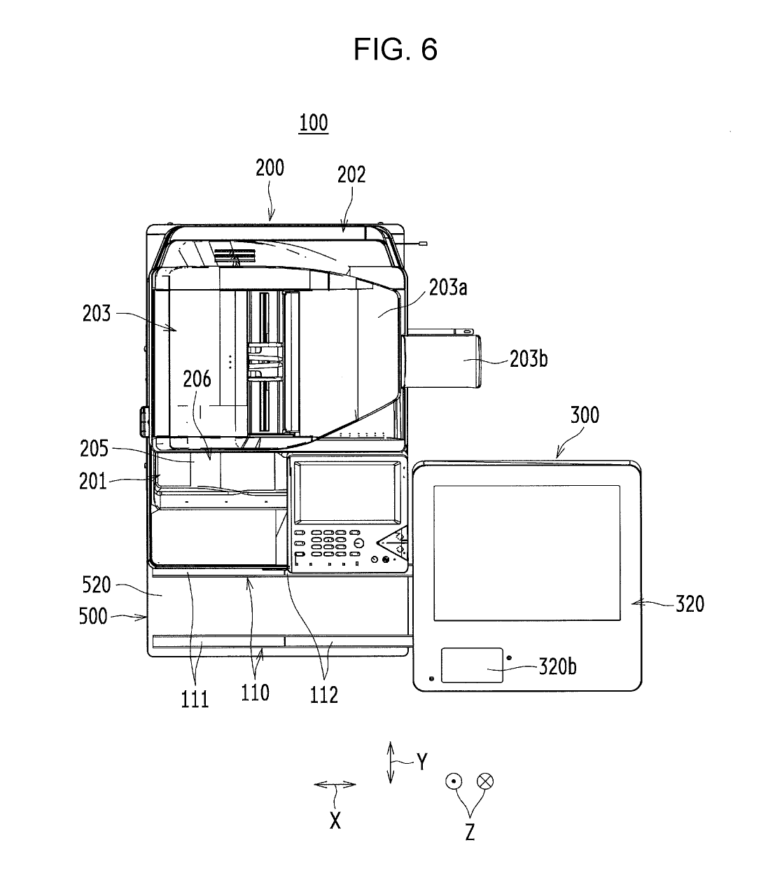

FIG. 5 is a schematic perspective view illustrating a state in which a separate unit 300 is located at a second position in the image forming system 100 according to a second embodiment. FIG. 6 is a schematic plan view illustrating a state in which the separate unit 300 is located at a first position in the image forming system 100 according to the second embodiment. In the image forming system 100 according to the first embodiment, the separate unit 300 is configured to be rotatable. In contrast, in the image forming system 100 according to the second embodiment, the separate unit 300 is configured to be slidable in the right-left direction X. Other configurations are substantially the same as those of the image forming system 100 according to the first embodiment. In the second embodiment, the elements that are substantially the same as those in the first embodiment are denoted by the same reference symbols.

In the second embodiment, the first position is a position other than the position in front of the image forming apparatus 200. Space in front of the image forming apparatus 200 can be thereby made available.

In the second embodiment, the first position is a position between a region on the right of the image forming apparatus 200 and a region in front of the image forming apparatus 200 or a position between a region on the left thereof and a region in front thereof (in the present example, the first position is the position between the region on the right of the image forming apparatus body 201 and the region in front of the image forming apparatus body 201). Accordingly, when the separate unit 300 is located at the first position, space on the right or on the left of the image forming apparatus 200 is made available.

In the second embodiment, the separate unit 300 is formed so as to be slidable between the first position and the second position in the right-left direction X. Thus, the separate unit 300 can be slid reciprocally between the first position and the second position in the right-left direction X with a simple configuration and with easy operation.

More specifically, the image forming system 100 has slide rails 110 (in the present example, two slide rails 110). The separate unit 300 is mounted on the pedestal 500 via the slide rails 110. Each of the slide rails 110 is constituted by a first slider and a second slider 112 which slide against each other. The pedestal 500 has a projecting portion 520 that is lower part of the pedestal 500 and projects frontward. The first slider 111 and the second slider 112 extend in the right-left direction X. The first slider 111 is disposed in such a manner that the surface of the first slider 111 that is opposite to the surface thereof that comes into contact with the second slider 112 is attached to the top surface of the projecting portion 520 of the pedestal 500. The second slider 112 is disposed such that the surface of the second slider 112 that is opposite to the surface thereof that comes into contact with the first slider 111 is attached to the bottom surface of the lower portion 340 of the separate unit 300.

Note that the first position may be a position on the right or on the left of the image forming apparatus 200. In this case, the slide rails 110 can be disposed in front of the image forming apparatus 200 and on the right and/or left of the image forming apparatus 200. The slide rails 110 can be thereby formed into an L shape or a U shape in plan view (when viewed from above).

### Third Embodiment

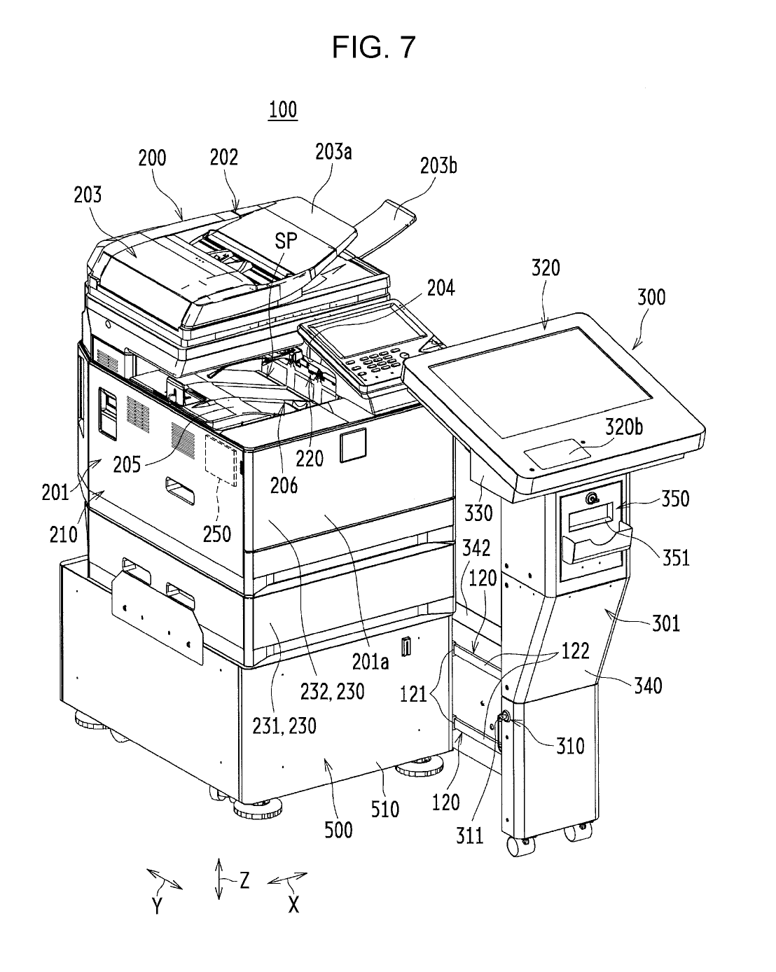

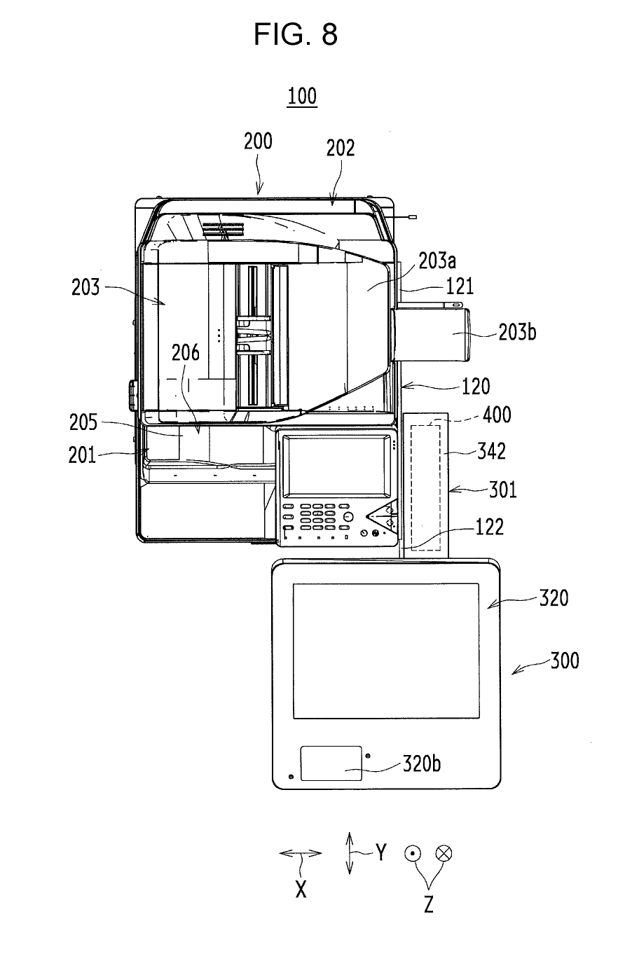

FIG. 7 is a schematic perspective view and FIG. 8 is a schematic front view, both of which illustrate a state in which a separate unit 300 is positioned at a first position in the image forming system 100 according to the third embodiment. In the image forming system 100 according to the first embodiment, the separate unit 300 is configured to be rotatable. In contrast, in the image forming system 100 according to the third embodiment, the separate unit 300 is configured to be slidable in the front-rear direction Y. Other configurations are substantially the same as those of the image forming system 100 according to the first embodiment. In the third embodiment, the elements that are substantially the same as those in the first embodiment are denoted by the same reference symbols.

In the third embodiment, the first position is a position at a distance in front of the image forming apparatus 200. Space except for the space in front of the image forming apparatus 200 can be thereby made available.

In the third embodiment, the separate unit 300 is formed so as to be slidable between the first position and the second position in the front-rear direction Y. Thus, the separate unit 300 can be slid reciprocally between the first position and the second position in the front-rear direction Y with a simple configuration and with easy operation.

More specifically, the image forming system 100 has slide rails 120 (in the present example, two slide rails 120). The separate unit 300 is mounted on the pedestal 500 via the slide rails 120. Each of the slide rails 120 is constituted by a first slider 121 and a second slider 122 which slide against each other. The separate unit 300 includes an extension portion 342 that extends rearward from lower part of the lower portion 340. Accordingly, the lower portion 340 is formed into an L shape in plan view (when viewed from above). The first slider 121 and the second slider 122 extend in the front-rear direction Y. The first slider 121 is disposed such that the surface of the first slider 121 that is opposite to the surface thereof that comes into contact with the second slider 122 is attached to the right side of the pedestal 500. The second slider 122 is disposed such that the surface of the second slider 122 that is opposite to the surface thereof that comes into contact with the first slider 121 is attached to the left side of the extension portion 342 of the separate unit 300. In the present example, the control unit 400 is disposed inside the extension portion 342 instead of inside the pedestal 500 (see FIG. 8).

Note that the separate unit 300 is disposed on the right side of the pedestal 500 in the first and third embodiments, but the separate unit 300 may be disposed on the left side of the pedestal 500. The first position is on the right of the image forming apparatus 200 in the first to third embodiments, but the first position may be positioned on the left of the image forming apparatus 200. In addition, the separate unit 300 is mounted on the pedestal 500 in the first to third embodiments, but the separate unit 300 may be mounted on the image forming apparatus 200.

The present disclosure is not limited to the embodiments described above but can be implemented in various other forms. Accordingly, the embodiments described above are merely examples in all respects and are not be construed to be limited.

The present disclosure contains subject matter relates to that disclosed in Japanese Priority Patent Application JP 2017-212004 filed in the Japan Patent Office on Nov. 1, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming system comprising:
an image forming apparatus; and
a separate unit that is separated from the image forming apparatus, wherein
the image forming apparatus includes an opening/closing section that is disposed on a front side of the image forming apparatus and that opens frontward, and
the separate unit is configured to be movable along a predetermined movement path between a predetermined first position at which the opening/closing section is operable/closable and a predetermined second position that is positioned in front of the image forming apparatus and at which the separate unit blocks at least part of the opening/closing section in such a manner that the opening/closing section is not opened.

2. The image forming system according to claim 1, wherein
the first position is not a position in front of the image forming apparatus.

3. The image forming system according to claim 2, wherein
the first position is a position on the right of the image forming apparatus or on the left of the image forming apparatus.

4. The image forming system according to claim 2, wherein
the first position is a position between a region on the right of the image forming apparatus and a region in front of the image forming apparatus or a position between a region on the left of the image forming apparatus and a region in front of the image forming apparatus.

5. The image forming system according to claim 1, wherein
the first position is a position at a distance in front of the image forming apparatus.

6. The image forming system according to claim 1, wherein
the separate unit is configured to be rotatable between the first position and the second position.

7. The image forming system according to claim 1, wherein
the separate unit is configured to be slidable between the first position and the second position.

8. The image forming system according to claim 1, further comprising:
a first display that is disposed in the separate unit; and
a second display that is disposed in the image forming apparatus, wherein
the first display uncovers entire part of the second display when the separate unit is located at the first position, and
the first display covers at least part of the second display when the separate unit is located at the second position.

9. The image forming system according to claim 8, further comprising:
a document feeder that is disposed in an upper portion of the image forming apparatus and has a document feeder tray, wherein
the first display is positioned in front of the document feeder when the separate unit is located at the second position and is also positioned at a level lower than or equal to a level of the document feeder tray of the document feeder when the separate unit is located at least at the second position.

10. The image forming system according to claim 8, wherein
the separate unit includes a lower portion that extends downward from the first display.

11. The image forming system according to claim 10, wherein
the lower portion is formed so as to follow the front side of the image forming apparatus.

12. The image forming system according to claim 10, wherein
the lower portion causes the opening/closing section to be openable/closable when the separate unit is located at the first position, and
the lower portion blocks at least the part of the opening/closing section in such a manner that the opening/closing section is not opened when the separate unit is located at the second position.

13. The image forming system according to claim 8, wherein
the first display has a tilt mechanism that rotates the first display around a rotation axis extending in a horizontal direction or substantially in a horizontal direction.

14. The image forming system according to claim 8, further comprising:
a control unit that operates and controls the image forming apparatus in accordance with an instruction signal from the separate unit, wherein
the first display and the second display are configured to be switched between a first display state in which the first display is activated and the second display is not activated and a second display state in which the second display is activated and the first display is not activated, and
the first display and the second display are switched to the first display state when the control unit is supplied with electric power and are switched to the second display state when the control unit is not supplied with electric power.

15. The image forming system according to claim 1, wherein
the opening/closing section includes a sheet container that is drawable frontward and/or an opening/closing cover that is turnable frontward.

16. The image forming system according to claim 1, wherein
the image forming apparatus includes a discharge tray on which a sheet is placed and is provided with a sheet takeout opening in a front region in the image forming apparatus for taking out the sheet placed on the discharge tray, and
the separate unit exposes at least part of the sheet takeout opening when the separate unit is located at the second position.

17. The image forming system according to claim 1, further comprising:
a pedestal on which the image forming apparatus is mounted, wherein
the pedestal has a pedestal opening/closing portion that is disposed on a front side of the pedestal and opens frontward,
the separate unit causes the pedestal opening/closing portion to be openable/closable when the separate unit is located at the first position, and
the separate unit blocks at least part of the pedestal opening/closing portion in such a manner that the pedestal opening/closing portion is not opened when the separate unit is located at the second position.

18. The image forming system according to claim 1, further comprising:
a pedestal on which the image forming apparatus is mounted, wherein
the separate unit is disposed on the pedestal.

19. The image forming system according to claim 1, wherein
the separate unit is disposed on the image forming apparatus.

20. The image forming system according to claim 1, wherein
the separate unit includes a printer that is disposed in such a manner that a discharge opening of the printer for discharging a printout faces frontward when the separate unit is located at the second position.
